(19) United States
(12) Patent Application Publication
(10) Pub. No.: US 2026/0014705 A1
(43) Pub. Date: Jan. 15, 2026

(54) MICROROBOT PLATFORM AND USER INTERFACE FOR EYELASH ENHANCEMENT

(71) Applicant: L'Oreal, Paris (FR)

(72) Inventors: Grégoire Charraud, Jersey City, NJ (US); Rafael Feliciano, New Providence, NJ (US)

(73) Assignee: L'Oreal, Paris (FR)

(21) Appl. No.: 18/770,507

(22) Filed: Jul. 11, 2024

(51) Int. Cl. B25J 9/16; A41G 5/02; G05B 19/4155; G06T 19/00; G06V 10/44; G06V 40/16

(52) U.S. Cl. CPC B25J 9/1697; A41G 5/02; G05B 19/4155; G06T 19/00; G06V 10/44; G06V 40/171; G05B 2219/50391; G06T 2200/24

(57) ABSTRACT

A method of controlling one or more microrobots to apply eyelash enhancements comprises obtaining digital source image data of a subject; defining an eyelash region of the subject in the source image data; generating an eyelash map based at least in part on analysis of the defined eyelash region; and generating microrobot control instructions based at least in part on the eyelash map. The control instructions are configured to cause the microrobot(s) to apply lashes to the subject based on the eyelash map. Defining the eyelash region may include extracting facial landmarks (e.g., points or contours) from the source image data, identifying the eyelash region based on the facial landmarks, and applying an image mask corresponding to the eyelash region. A modified image or 3D model can be generated based on the source image data and an eyelash recommendation. The control instructions may be further based on the eyelash recommendation.

### SUMMARY

In one aspect, a computer-implemented method of controlling one or more microrobots to apply eyelash enhancements comprises obtaining digital source image data of a subject; defining an eyelash region of the subject in the digital source image data; generating an eyelash map based at least in part on analysis of the defined eyelash region; and generating microrobot control instructions based at least in part on the eyelash map, wherein the microrobot control instructions are configured to cause one or more microrobots to apply one or more artificial lashes to the subject based on the eyelash map.

In some embodiments, defining the eyelash region includes obtaining facial landmarks (e.g., eye points or contours or eyebrow points or contours) from the digital source image data, identifying the location and shape of the eyelash region based on the facial landmarks, and applying an image mask corresponding to the eyelash region to the digital source image data.

In some embodiments, the method further comprises providing the eyelash map to an eyelash recommendation engine; and by the eyelash recommendation engine, generating an eyelash recommendation based at least in part on the eyelash map, wherein the eyelash recommendation comprises a position on an eyelid or existing eyelash of the subject for an artificial lash to be applied by the one or more microrobots.

In some embodiments, the method further comprises performing attribute analysis on the digital source image data to identify one or more attributes of the subject (e.g., a face shape attribute, an age attribute, an eye attribute, an eyebrow attribute, a skin tone attribute, a skin texture attribute, a skin condition attribute, a hair attribute), wherein the eyelash recommendation is further based on the one or more facial attributes.

In some embodiments, the method further comprises providing the digital source image data and the eyelash recommendation to an image generation module; and generating a modified image or 3D model based on the digital source image data and the eyelash recommendation.

In some embodiments, the method further comprises displaying the modified image or 3D model in an eyelash enhancement user interface.

In some embodiments, the eyelash enhancement user interface further includes virtual try-on functionality that allows modification of the eyelash recommendation via user interaction with the modified image or 3D model.

In some embodiments, the microrobot control instructions are further based on the eyelash recommendation.

In some embodiments, the method further comprises receiving user input from an eyelash enhancement user interface, wherein the microrobot control instructions are further based on the user input.

In another aspect, a system comprises circuitry configured to perform any of the method or process steps identified herein, including circuitry configured to obtain digital source image data of a subject; circuitry configured to define an eyelash region of the subject in the digital source image data; circuitry configured to generate an eyelash map based at least in part on analysis of the defined eyelash region; and circuitry configured to generate microrobot control instructions based at least in part on the eyelash map, wherein the microrobot control instructions are configured to cause one or more microrobots to apply one or more artificial lashes to the subject based on the eyelash map.

In some embodiments, the system further comprises one or more cameras configured to capture the digital source image data of a subject.

In some embodiments, the system further comprises the one or more microrobots.

In another aspect, non-transitory computer-readable media has stored thereon instructions configured to cause one or more computing devices to perform any of the method or process steps identified herein.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a schematic illustration of a non-limiting example embodiment of a system for automated eyelash enhancements using microrobots, according to various aspects of the present disclosure;

FIG. 1B is a block diagram that illustrates non-limiting example embodiments of a client computing device that may be used to implement aspects of the present disclosure;

FIGS. 2A-2E are example systems for applying eyelashes, in accordance with aspects of the present disclosure;

FIGS. 3A-3F are example microrobots, in accordance with aspects of the present disclosure;

FIGS. 4A-4B show another example system for applying eyelashes, in accordance with aspects of the present disclosure;

FIG. 5 is a flow chart of a method of controlling one or more microrobots to apply eyelash enhancements, in accordance with aspects of the present disclosure; and

FIG. 6 is a block diagram of an example workflow for applying eyelashes, in accordance with aspects of the present disclosure.

### DETAILED DESCRIPTION

Disclosed herein is an automated and robotic eyelash extension system. In some embodiments, the system includes a computer vision system including one or more cameras that identifies and determines positions of existing lashes; a recommendation engine or eyelash placement engine that determines where to place artificial lashes; and a microrobot control module that determines, e.g., two-dimensional (2D) or three-dimensional (3D) coordinates and movement patterns for motion-controlled lash placement microrobots and schedules movements/trajectories of such microrobots. In some embodiments, the computer vision system includes multiple cameras (e.g., in a stereoscopic camera system). In some embodiments, the computer vision system and the recommendation/lash placement engine work together to identify existing natural lashes and their location on the user's eyelids, to determine characteristics of the lashes such as length and density, and to determine an eyelash extension that is appropriate for applying to the user's eyelids to supplement the natural lashes (e.g., using machine learning (ML)-based face or object recognition techniques and/or product recommendation techniques). In some embodiments, the output of the lash placement/recommendation engine is presented to a user in a client application that provides functionality for assessment/diagnosis of existing eyelash condition and a user interface for selecting eyelash placement strategies to achieve a desired look. In some embodiments, options for possible looks are provided by an eyelash recommendation engine, and a modified version of an image of the user can be presented with eyelash recommendations incorporated in the modified image. In some embodiments, a digital twin or a virtual 3D model of the user's face or eyelash region(s) is presented in the user interface to allow virtual placement of eyelashes (e.g., based on a user-selected look or a look recommended by a recommendation engine), which can allow users to virtually try on different eyelash looks before performing microrobot operations.

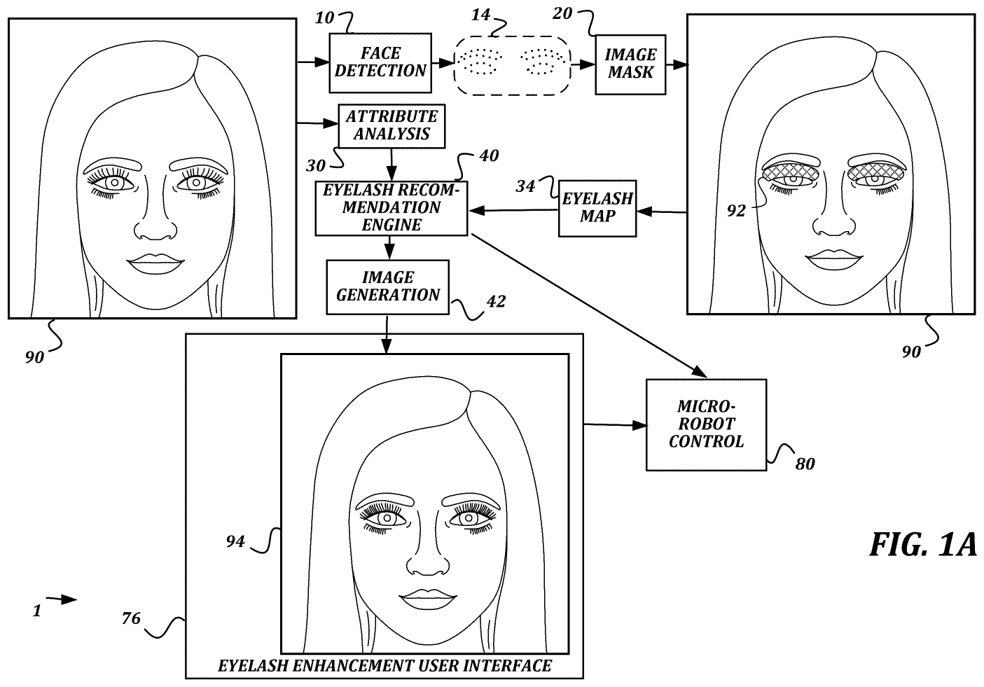

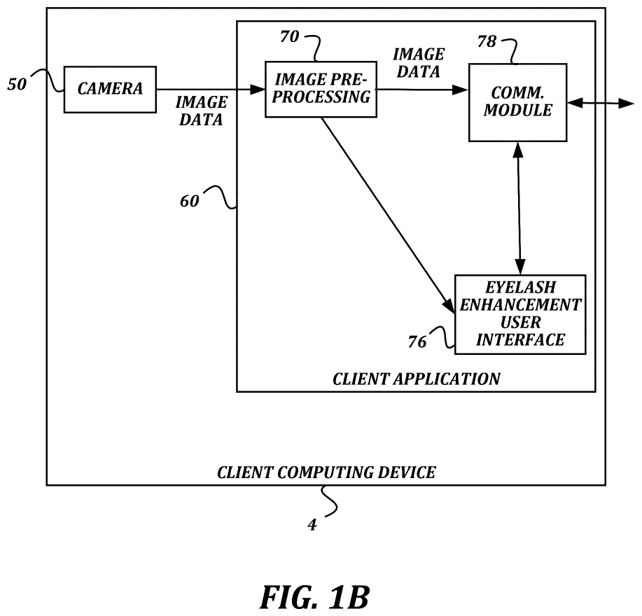

FIG. 1A is a schematic illustration of a non-limiting example embodiment of a system 1 for automated eyelash enhancements using microrobots, according to various aspects of the present disclosure. In some embodiments, components of system 1 are implemented by a client computer device, a server computer system, or a combination thereof. In the example shown in FIG. 1A, digital source image data in the form of one or more digital source images 90 is provided to face detection module 10, which detects a face in the source image. Face detection module 10 provides facial feature information to image mask module 20, which calculates a region in source image 90 in which corresponding image information (e.g., pixel information) is to be masked or removed (e.g., by cropping). In an illustrative implementation, face detection module 10 comprises machine-learning (ML)-based face detection, such as the face detection application programming interface (API) for ML Kit, available from Google LLC. In the example shown in FIG. 1A, the facial feature information includes a set of facial landmarks (e.g., points or contours) 14 (e.g., points or contours corresponding to eyelids, eyelashes, eyebrows, or the like). Image mask module 120 uses facial landmarks 14 to calculate an image mask region 92, which corresponds to boundaries of one or more eyelash regions for one or more eyes. For example, image mask module 120 may identify a region between a lower boundary of an eyebrow and an upper eyelid as an eyelash region. In the example shown in FIG. 1A, image mask region 92 corresponds to a left upper eyelash region and a right upper eyelash region depicted in source image 90. With boundaries of the eyelash region(s) determined, system 1 detects and maps individual lashes in eyelash map module 34, which generates an eyelash map. Eyelash map module can then provide the eyelash map to microrobot control module 80 to guide application of artificial lashes at appropriate locations, as described in further detail herein.

In some embodiments, eyelash map module 34 creates skeletons of individual eyelashes in the defined eyelash region(s) by determining proximal and distal endpoints of the eyelashes as well as lengths. In an illustrative scenario, eyelash map module 34 assumes the eyelash shape to be an arc of a circle rather than a straight line, and determines length of the individual eyelashes on this basis. Eyelash map module 34 also can create boundaries or windows of portions of eyelashes, identify how many lashes are present in the entire eyelash or in segments thereof, and calculate characteristics such as lash density (e.g., number of lashes per 5 mm segment or some other segment size), average lash length, individual lash lengths, average lash thickness, individual lash thicknesses, etc. All of this information, or portions of such information or additional information, can be included in the eyelash map in various embodiments. In some embodiments, eyelash map module 34 uses ML-based face or object recognition techniques to detect and measure eyelashes, or to detect and identify anomalies in eyelash regions within an eyelash map (e.g., missing eyelashes, short eyelashes, damaged eyelashes, gaps in eyelashes, etc.). Identified anomalies and can be useful for generating corresponding eyelash enhancement recommendations.

In some embodiments, system 1 performs facial attribute analysis of facial features to determine options for application of artificial lashes (e.g., to address a particular condition, such as sparse, uneven, short, or damaged eyelashes, or to achieve a desired look). In the example shown in FIG. 1A, facial analysis module 30 identifies one or more facial attributes of the subject of the image and provides the attribute(s) to eyelash recommendation module 40, which generates an eyelash enhancement recommendation based at least in part on the identified facial attributes. In some embodiments, facial attributes considered by the eyelash recommendation module in generating a recommendation include one or more face shape attributes, age attributes, eye attributes (e.g., shape, size, color), eyebrow attributes (e.g., shape, size, color), a skin tone attribute, a skin texture attribute (e.g., wrinkles, firmness), a skin condition attribute (e.g., blemishes, dryness, oiliness, redness), a hair attribute (e.g., color, texture, length). In some embodiments, ML-based recommendations (e.g., using an artificial neural network approach) may be used to identify desirable eyelash enhancements based on a user's combination of attributes. In some embodiments, the eyelash enhancement recommendation includes identifying locations on eyelids at which artificial lashes are to be applied to address a condition or achieve a desired look.

In some embodiments, system 1 presents eyelash recommendations in a user interface, e.g., for approval by a user or to provide options for further modifications. In the example shown in FIG. 1A, system 1 provides an eyelash enhancement recommendation along with existing eyelash information (e.g., an eyelash map generated by eyelash map module 34) to image generation module 42, which generates modified image 94 based on source image 90, the existing eyelash information, and the eyelash enhancement recommendation. In this example, in modified image 94 the upper lash area in each eye has been supplemented with depictions of additional lashes in gap areas between existing lashes on the upper eyelids, resulting in fuller upper lashes, and modified image 94 is displayed in eyelash enhancement user interface 76 (e.g., on a smartphone display or a display of some other client computing device).

In some embodiments, system 1 allows a user to provide additional input to modify or control an eyelash enhancement process. In the example shown in FIG. 1A, a user (e.g., a subject of source image 90 or a salon professional) provides input via user interface 76 to select, modify, or confirm an eyelash enhancements and/or initiate an eyelash enhancement process by sending control signals to microrobot control module 80, which carries out application of lashes according to one or more techniques described herein.

FIG. 1B is a block diagram that illustrates non-limiting example embodiments of a client computing device 4 according to various aspects of the present disclosure. Client computing device 4 may be used to implement one or more aspects of system 1, including all or some of the modules and functionality depicted in FIG. 1A, in any combination. In an illustrative scenario, client computing device 4 captures one or more digital source images of a user, transmits the image data to another computer system (such as a server computer system) for processing, receives modified image data, and implements eyelash enhancement user interface 76. Client computing device 4 may communicate with other computers or system using any suitable communication technology, such as wireless communication technologies including but not limited to Wi-Fi, Wi-MAX, Bluetooth, 3G, 4G, 5G, and LTE; or wired communication technologies including but not limited to Ethernet, Fire Wire, and USB.

In the illustrated embodiment, client computing device 4 includes a camera 50 and client application 60, which includes image pre-processing engine 70, eyelash enhancement user interface 76, and communication module 78. User interface 76 may present different types of functionality to a user, such as guides, tutorials, or virtual “try-on” functionality for exploring new products or looks. This technology may, in some embodiments, allow users to virtually try different looks or products (e.g., lashes of different lengths, colors, thicknesses, finishes, etc., or related cosmetics such as mascara or eye shadow) by applying virtual lashes or cosmetics to 2D face images or a virtual 3D model of a user's face. This technology may use source images or modified images of the user, which may be generated in accordance with embodiments described herein. In some embodiments, the user interface includes a graphical user interface to assist a user in obtaining high-quality source images on which the modified images may be based.

In some embodiments, image pre-processing engine 70 is configured to pre-process images, e.g., before they are transmitted to an image processing computer system. In some embodiments, image pre-processing engine 70 performs image normalization, which may include, for example, color correction, noise reduction or filtering; adjusting orientation; cropping; adjusting brightness/exposure; or adjusting contrast. In an illustrative scenario, an image includes an off-center face where an area of interest, such as the user's eyes, takes up only a small portion of the overall image. To allow for more accurate or photorealistic image modification, it may be desirable to reduce the area in the image that is not of interest. This may be accomplished by, for example, using a face detection algorithm to detect the portion of the image that depicts the eyes, centering the eyes within the image, and zooming in on the eyes to cause the eyes to occupy a larger portion of the image. Other possible normalization actions include cropping the image, reducing or increasing bit depth, undersampling or oversampling pixels of the image, or the like. The image data can then be sent (potentially along with other information, such as a user ID, device ID, or the like) to communication module 78 for subsequent formatting and transmission to an image processing system. (Other features of the client computing device 4 are not shown in FIG. 1B for ease of illustration.)

Many alternatives to the arrangements and usage scenarios depicted in FIGS. 1A and 1B are possible. For example, although the descriptions of FIGS. 1A and 1B illustrate various components as being provided by client computing device 4 or a server computer system, in some embodiments, the arrangement or functionality of the components may be different. For example, functionality described as being performed by client computing device 4 may instead be performed by a server computer system, or vice versa, or such functionality may be performed by different devices or systems. As another example, functionality described as being performed by a particular module or component may instead be performed by a combination of such modules or components, or by a different module or component, or functionality described as being performed by individual modules or components may be combined in a single module or component.

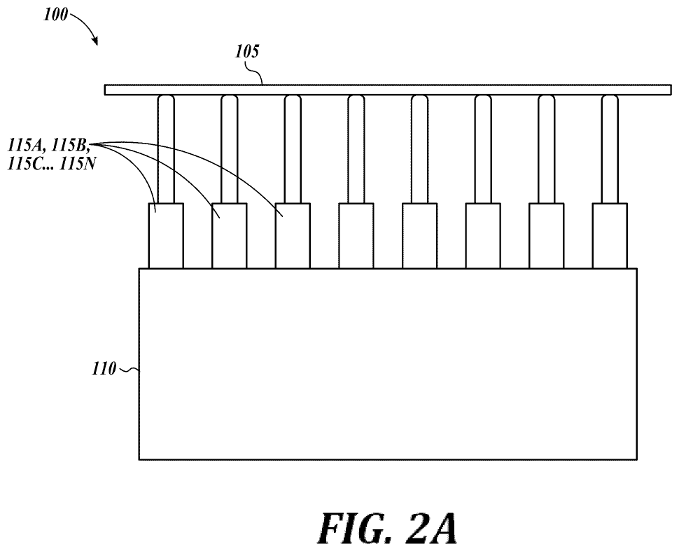

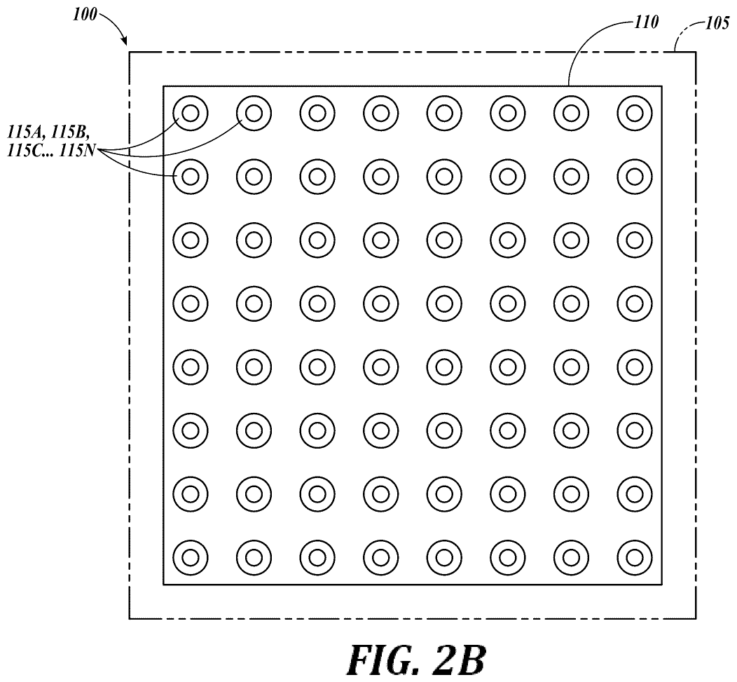

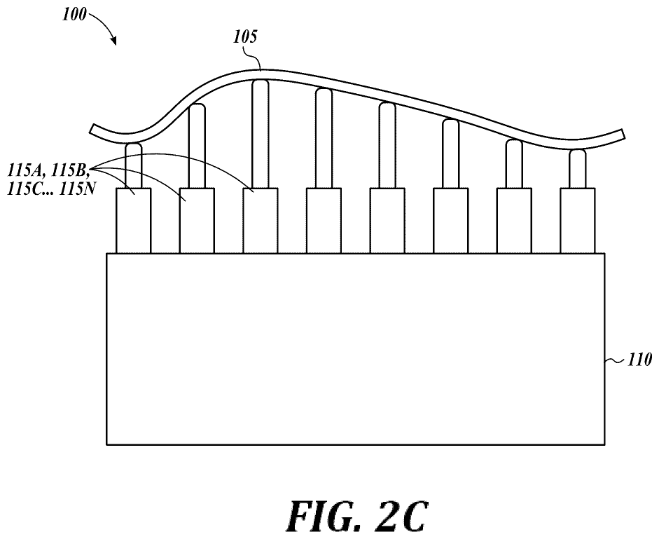

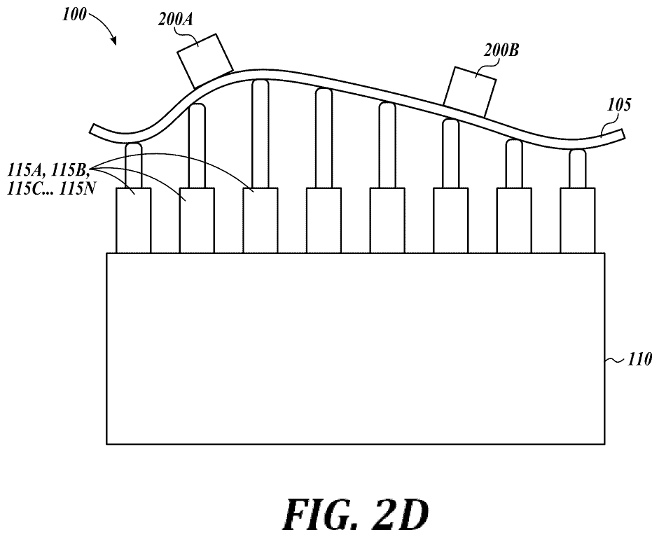

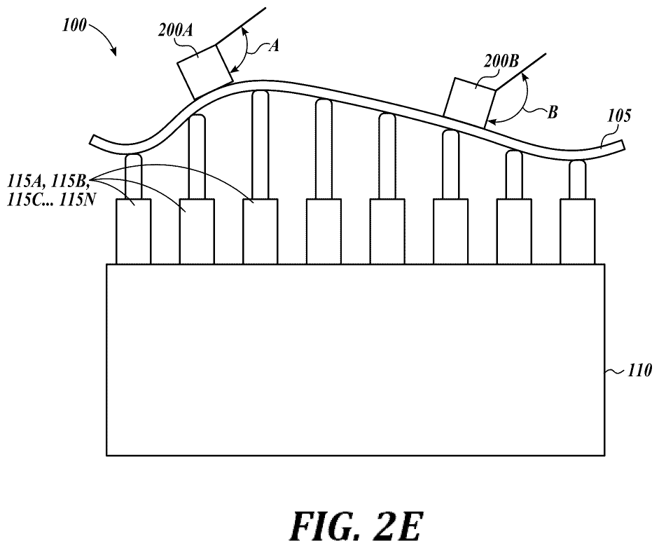

FIGS. 2A-2E are example systems 100 for applying eyelashes in accordance with the present technology.

As shown in FIG. 2A, system 100 may include a flexible printed circuit board (PCB) substrate 105, a motor base 110, and one or more linear actuators 115A, 115B, 115C . . . 115N. In some embodiments, flexible PCB substrate 105 is configured to bend and/or curve in response to linear actuators 115A, 115B, 115C . . . 115N (which may be referred to as “adjusting” the PCB substrate 105).

In some embodiments, motor base 110 is disposed the flexible PCB substrate 105. Motor base 100 is coupled to linear actuators 115A, 115B, 115C . . . 115N and is configured to drive and direct linear actuators 115A, 115B, 115C . . . 115N to move up and down to adjust PCB substrate 105.

FIG. 2B is a top-down perspective of the system 100. The flexible PCB substrate 105 may be disposed on top of a plurality of linear actuators 115A, 115B, 115C . . . 115N. The flexible PCB substrate 105 is shown as dashed lines in FIG. 6B to better show the position of the plurality of linear actuators 115A, 115B, 115C . . . 115N.

In some embodiments, linear actuators 115A, 115B, 115C . . . 115N are disposed in an array. Each of the linear actuators 115A, 115B, 115C . . . 115N may move independently, allowing for numerous adjustments to flexible PCB substrate 105.

FIG. 2C shows where linear actuators 115A, 115B, 115C . . . 115N have adjusted flexible PCB substrate 105. In operation, each of linear actuators 115A, 115B, 115C . . . 115N moves independently to bend, curve, and otherwise manipulate flexible PCB substrate 105.

As shown in FIG. 2D, one or more microrobots 200A, 200B may slide or levitate over flexible PCB substrate 105. In some embodiments, flexible PCB substrate 105 is adjusted before one or more microrobots 200A, 200B move over it. In other embodiments, flexible PCB substrate 105 may be adjusted dynamically, that is, while one or more microrobots 200A, 200B are in motion. In some embodiments, flexible PCB substrate 105 is configured to adjust a pitch, a yaw, a roll, or a combination thereof of one or more microrobots 200A, 200B.

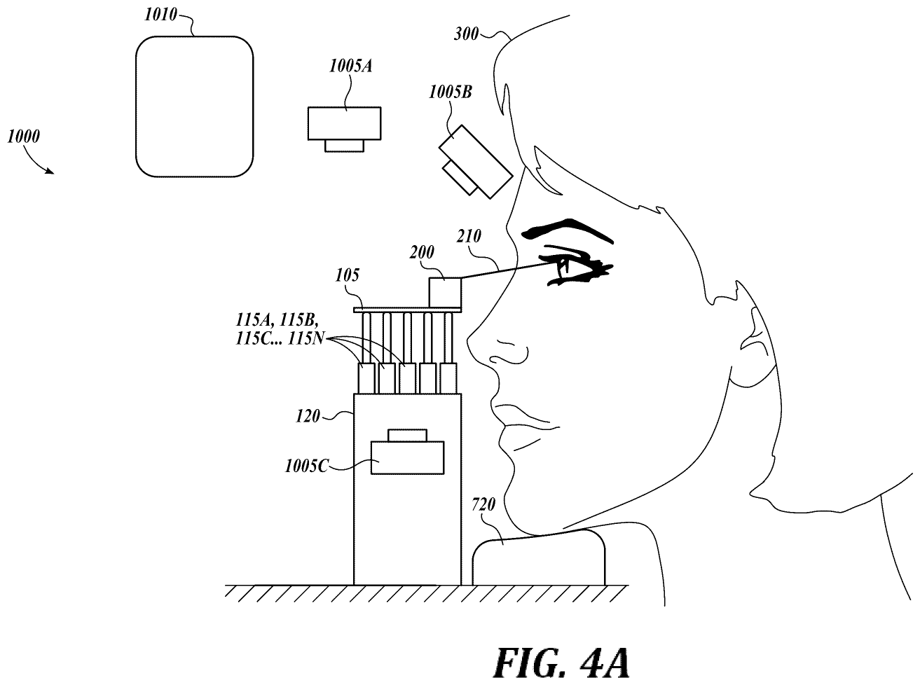

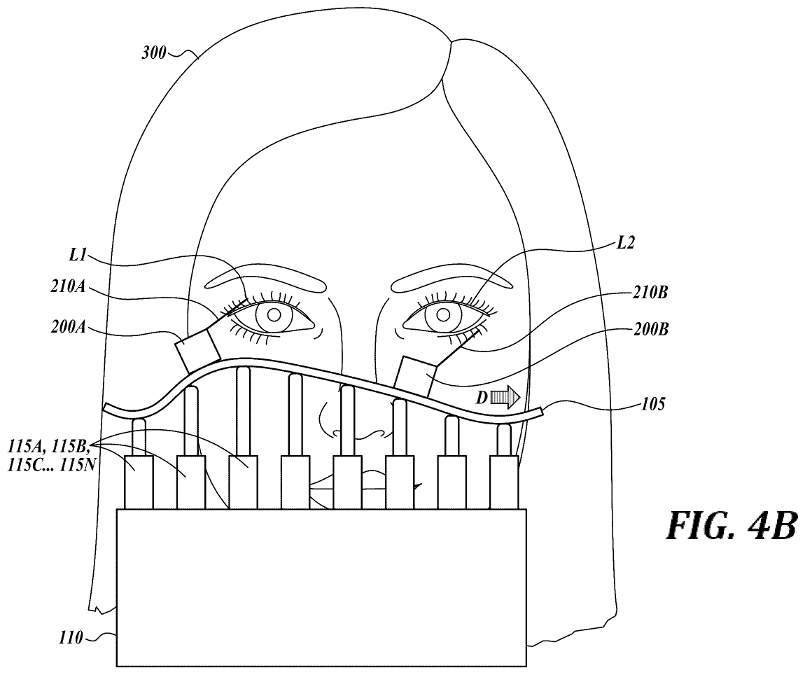

FIG. 2E shows microrobots 200A, 200B having applicators. As microrobots 200A, 200B move across flexible PCB substrate 105, an angle A, B between the applicator and flexible PCB substrate 105 changes. In some embodiments, the applicators are disposed at an angle. These angles A, B are referred to as “angles of attack,” meaning that angles A, B allow for the applicators to apply an eyelash to a user's eyelid or an existing eyelash, as shown in FIGS. 4A-4B. In such embodiments, the flexible PCB substrate is configured to adjust the angle of attack of the applicators.

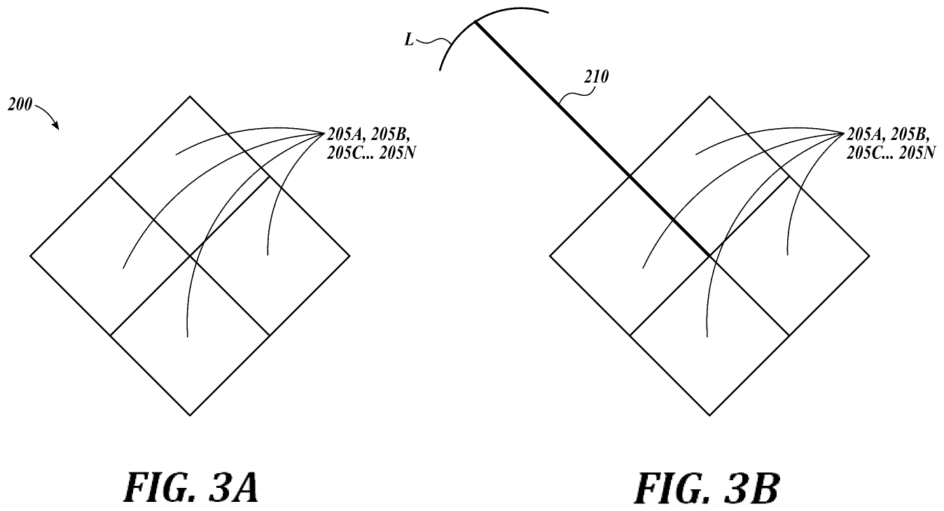

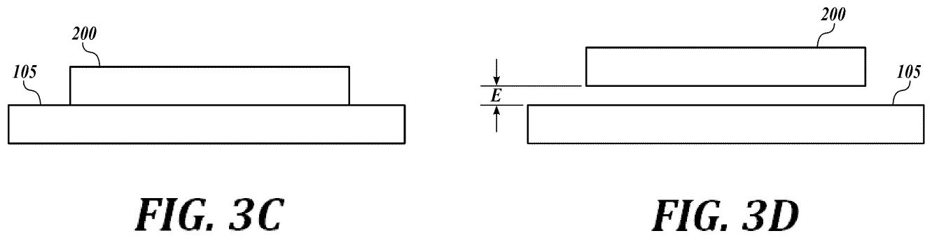

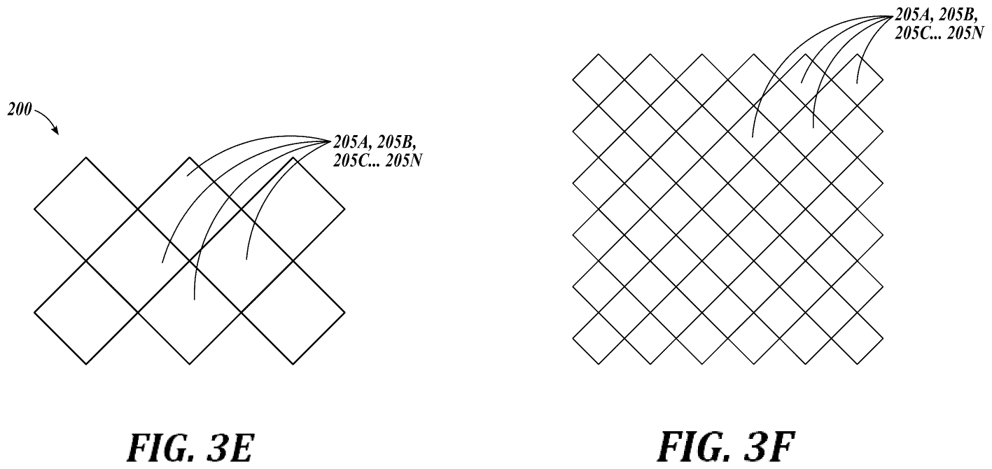

FIGS. 3A-3F are example microrobots, in accordance with the present technology.

FIG. 3A depicts an example microrobot 200 including magnets 205A, 205B, 205C . . . 205N. FIG. 3B shows an example microrobot 200 having magnets 205A, 205B, 205C . . . 205N, applicator 210, and an artificial eyelash (or cluster of eyelashes) L. Applicator 210 is configured to hold an eyelash or eyelash cluster, for eventual application to an eyelid. As used herein, the term “eyelash cluster” means two or more eyelashes that have been grouped together, either by being manufactured together or attached together, such as with adhesive. Individual eyelashes within an eyelash cluster may have same or different lengths, thicknesses, colors, finishes, or the like.

FIGS. 3C-3D show example microrobots 200 positioned on or levitating over a printed circuit board (PCB) substrate 105. In some embodiments, the checkerboard configuration of a plurality of magnets (such as magnets 205A, 205B, 205C . . . 205N) in conjunction with a graphite layer of substrate 105 confines microrobot 200 to a specific location at coordinates (x, y, z) in a 3D coordinate space. A magnetic potential well may be generated to localize microrobot 200. In some embodiments, a magnetic force is generated by four PCB current traces located inside substrate 105. FIG. 3C shows a sliding substrate system. In such systems, microrobot(s) 200 are configured to slide across the substrate. FIG. 3D shows a levitating substrate system. In such embodiments, microrobot(s) 200 are configured to levitate off of substrate 105 by an elevation E.

FIGS. 3E-3F show various magnet layouts for microrobots 200. It should be understood that any number of magnets may be included. In some embodiments, magnets 205A, 205B, 205C . . . 205N are disposed in an alternating orientation, where the magnetization is alternated between adjacent magnets.

In some embodiments, microrobot(s) 200 are controlled by the local trace pattern and currents. That is, the microrobot's control is area- or zone-based rather than one that moves with the microrobot (as would be the case for conventional motorized robots). Zone control has both advantages and disadvantages for multi-agent control. The disadvantage of zone control is that two microrobots in close proximity may not be independently controlled unless they are in different independent zones. The advantage of zone control is that large numbers of microrobots may be controlled to execute the same motion in parallel using only a few control channels. The control zone approach generally reduces the numbers of control channels needed since the microrobots do not need to carry extra control channels in areas which need, for example, only one degree-of-freedom for transport.

In some embodiments, as described herein, microrobots may be configured to “cooperate” with one another by doing different steps in the process of applying eyelashes to a single eye or a single user having two eyes. For example, one or more microrobots 200 may be configured to separate out eyelashes, another microrobot may be configured to apply the lash, and yet another microrobot may be configured to apply an eyelash glue or adhesive.

FIGS. 4A-4B show another example system 1000 for applying eyelashes, in accordance with the present technology. In some embodiments, system 1000 includes flexible PCB substrate 105, a plurality of linear actuators 115A, 115B, 115C . . . 115N, motor base 120, one or more microrobots 200, chin rest 720, one or more cameras 1005A, 1005B, 1005C (which may be described collectively as a camera system) and processor 1010. A user 300 may use the system 1000 as shown in FIGS. 4A-4B.

While three cameras are shown in FIGS. 4A-4B, it should be understood that any number of cameras may be used as a camera system, including a single camera. In some embodiments, cameras 1005A, 1005B, 1005C are configured to capture user 300, one or more microrobots 200, flexible PCB substrate 105 or other components or subjects within their field of view. In some embodiments, cameras 1005A, 1005B, 1005C are communicatively coupled with processor 1010. Processor 1010 may be configured to determine a desired position (e.g., height) of linear actuators 115A, 115B, 115C . . . 115N, a new position of one or more microrobots, or both. System 1000 can use cameras 1005A, 1005B, 1005C to determine locations of elements such as flexible PCB substrate 105, one or more microrobots 200, applicator 210, or a combination thereof with the processor 1010. While processor 1010 is shown as being local to other components of system 1000, it should be understood that processor 1010 may be located anywhere, including a remote location connected to other components via a network, or incorporated directly into the system. In some embodiments, processor 1010 may be incorporated into a remote device such as a smart phone, desktop computer, laptop, or tablet. In some embodiments, processor 1010 is configured to communicatively couple with one or more cameras 1005A, 1005B, 1005C, motor base 120, one or more linear actuators 115A, 115B, 115C . . . 115N, and/or one or more microrobots 200.

In some embodiments, positioning one or more microrobots 200 onto the flexible PCB substrate 105 includes directing one or more microrobots 200 to slide or levitate over flexible PCB substrate 105. In some embodiments, positioning includes adjusting pitch, yaw, roll, or a combination thereof of one or more microrobots 200 with one or more linear actuators 115A, 115B, 115C . . . 115N under flexible PCB substrate 105. Adjusting the position of one or more microrobots 200 in one of or multiple ways described herein allows system 1000 to apply an eyelash with one or more microrobots.

In operation, as shown in FIG. 4A, user 300 may rest their chin on chin rest 720. In some embodiments, chin rest 720 may be omitted. In some embodiments, chin rest 720 is adjustable to position the eyes of user 300 such that one or more microrobots 200 can contact the user's lash line, eyelid, or the like. One or more cameras 1005A, 1005B, 1105C may monitor the position, orientation, and/or angle of one or more microrobots 200. One or more cameras 1005A, 1005B, 1005C may also determine a location of features of user 300 such as lash lines, eyelashes, and eyelids, e.g., using a face detection technique.

In some embodiments, a first camera 1005A is positioned to view flexible PCB substrate 105 from a top-down (or “bird's eye” view), a second camera 1005B is positioned to view flexible PCB substrate 105 from an angle, and third camera 1005C is positioned to view flexible PCB substrate 105 from the side. However, one skilled in the art will recognize that the camera system may be arranged in other configurations.

In some embodiments, one or more cameras 1005A, 1005B, 1005C transmit image data of one or more microrobots 200, flexible PCB substrate 105, and/or user 300 to processor 1010, which may then analyze this image data and adjust a position (e.g., height) of at least one actuator 115A, 115B, 115C . . . 115N and/or adjust a position of one or more microrobots 200. In some embodiments, adjusting the position of one or more microrobots 200 comprises adjusting an angle of attack of applicator 210 with linear actuators 115A, 115B, 115C . . . 115N.

In some embodiments, as shown in FIG. 4B, processor 1010, in conjunction with flexible PCB substrate 105 may position first microrobot 200A to apply a first eyelash L1 and position a second microrobot 200B to apply a second eyelash L2. In such embodiments, first microrobot 200A and second microrobot 200B may move along the flexible PCB substrate in direction D, applying eyelashes at different locations on user 300's left eye. In some embodiments, microrobots 200A, 200B may apply eyelashes contemporaneously. For example, first microrobot 200A may apply eyelashes to an eyelid of a first eye and second microrobot 200B may apply eyelashes to an eyelid of a second eye. In some embodiments, flexible PCB substrate 105 may adjust the position of one or more microrobots 200A, 200B such that applicators 210A, 210B are able to apply eyelashes or eyelash clusters to a top lash line, a bottom lash line, or both.

In operation, user 300 or a salon professional may select an eyelash style, such as with eyelash enhancement user interface 76 of application 60 running on client computing device 4 (see FIG. 1B). In some embodiments, client computing device 4 houses processor 1010. User 300 or a salon professional may modify their selection, view their selection on a photo or live feed, or receive a selection based on a questionnaire, personal preferences, or trending styles. After selecting the style and/or providing other user input, user 300 may then sit or stand at the system 1000. Processor 1010 may then direct one or more microrobots 200 to apply one or more eyelashes or eyelash clusters to achieve the selected style. One or more cameras 1005A, 1005B, 1005C monitor one or more microrobots 200 and user 300 to ensure the microrobots are directed to a location to apply one or more eyelashes or eyelash clusters to achieve the selected style. In some embodiments, processor 1010 further instructs one or more linear actuators 115A, 115B, 115C . . . 115N to adjust flexible PCB substrate 105 to position one or more microrobots 200.

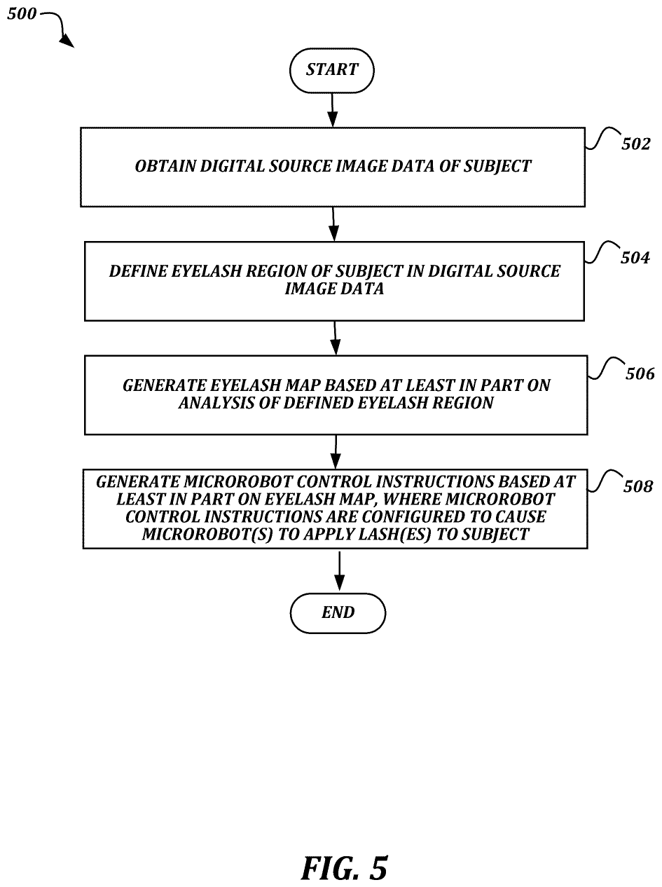

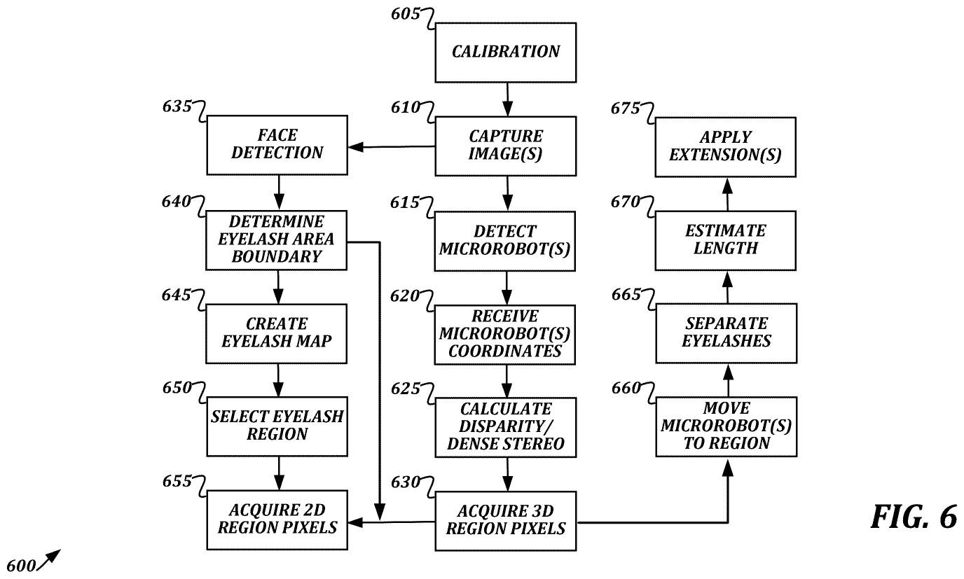

FIG. 5 is a flow chart of a method 500 of controlling one or more microrobots to apply eyelash enhancements. In some embodiments, method 500 is performed by system 1 depicted in FIG. 1A, or by some other device or system.

At block 502, the system obtains digital source image data of a subject (e.g., one or more digital images of user 300 depicted in FIG. 4A-4B). At block 504, the system defines an eyelash region of the subject in the digital source image data. At block 506, the system generates a eyelash map based at least in part on analysis of the defined eyelash region. At block 508, the system generates microrobot control instructions based at least in part on the eyelash map, wherein the microrobot control instructions are configured to cause one or more microrobots to apply one or more artificial lashes to the human subject based on the eyelash map.

FIG. 6 is a block diagram of an example workflow 600 for applying eyelashes, in accordance with the present technology. Workflow 600 may be performed by a single device or system or a combination of systems, such as system 1000 (see FIG. 4A-4B).

In block 605, the system is calibrated. In some embodiments, this is only done once. In some embodiments, calibration includes determining an initial position of a flexible PCB substrate (such as flexible PCB substrate 105) one or more microrobots (such as microrobots 200A, 200B), and/or a subject (such as user 300). In some embodiments, the calibration includes calibration of a camera system, which may include, e.g., correcting for optical distortion, lens aberrations, and the like.

In block 610, stereo image data is captured. In some embodiments, this is done with a camera system including one or more cameras. In some embodiments, the stereo image data allows for determination of depth information and can be used to create a snapshot of the eyelash region. In some embodiments, the stereo image data is captured in a controlled lighting environment to avoid problems with capturing accurate representations of the eyelash region due to poor lighting conditions (e.g., conditions that are too dark or that involve inconsistent light sources).

The captured image data can be used for detecting microrobots and their corresponding positions, as well as for detecting eyelash regions and creating maps of existing eyelashes. In the example shown in FIG. 6, in block 615, one or more microrobots are detected in the stereo image data. This allows the system to determine and receive microrobot position data (e.g., in the form of 3D coordinates) (block 620). In block 625, a dense disparity map of the stereo images is generated to match pixels in the stereo images. In block 630, 3D region pixels are acquired.

Referring again to block 610, after obtaining the stereo images, image data can be used to detect eyelash regions and eyelashes and create maps of existing eyelashes. In the example shown in FIG. 6, in block 635, face detection is performed. For example, face landmarks (e.g., eyelid contours) may be detected in the stereo images. In block 640, an image mask is applied to determine the boundary of one or more eyelash regions (e.g., an eyelash region of one eye or eyelash regions for both eyes of a subject). An eyelash map is created.

In block 650, an eyelash region (or portion thereof) is selected. For example, the eyelid within an eyelash region is split into 5 mm segments, and an initial segment for eyelash application is selected.

In block 655, two-dimensional (2D) regions of pixels of the eyelid are acquired. In conjunction with the 3D region of pixels of the desired position of the microrobot(s) (block 630), microrobot control instructions can be generated, and the instructions can be executed to cause the microrobot(s) to be moved to a correct region in block 660.

In block 665, eyelashes may be separated out by the microrobot(s). In some embodiments, the eyelashes are then visualized again by returning to block 610 for further processing. Thus, images of the separated eyelashes may go through the same processing steps in blocks 610-655.

In block 670, the length of the eyelashes may be estimated (e.g., based on detected proximal and distal endpoints of individual lashes). In block 675, the extension (eyelash and/or eyelash cluster) is applied (e.g., by executing corresponding microrobot control instructions generated by system 1 (FIG. 1A).

While illustrative embodiments have been illustrated and described, it will be appreciated that various changes can be made therein without departing from the spirit and scope of the invention.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Versatile Disk (DVD), Blu-Ray Disc, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to flash memory, magnetic tape, magneto-optic disk, non-volatile memory card, EEPROM, optical disk, optical storage, RAM, ROM, system memory, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure May include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the scope of the present disclosure.

We claim:

1. A computer-implemented method of controlling one or more microrobots to apply eyelash enhancements, the method comprising:
obtaining digital source image data of a subject;
defining an eyelash region of the subject in the digital source image data;
generating an eyelash map based at least in part on analysis of the defined eyelash region; and
generating microrobot control instructions based at least in part on the eyelash map, wherein the microrobot control instructions are configured to cause one or more microrobots to apply one or more artificial lashes to the subject based on the eyelash map.

2. The method of claim 1, wherein defining the eyelash region includes obtaining facial landmarks from the digital source image data, identifying the location and shape of the eyelash region based on the facial landmark points, and applying an image mask corresponding to the eyelash region to the digital source image data.

3. The method of claim 2, wherein the facial landmarks include eye points or contours or eyebrow points or contours.

4. The method of claim 1 further comprising:
providing the eyelash map to an eyelash recommendation engine; and
by the eyelash recommendation engine, generating an eyelash recommendation based at least in part on the eyelash map, wherein the eyelash recommendation comprises a position on an eyelid or existing eyelash of the subject for an artificial lash to be applied by the one or more microrobots.

5. The method of claim 4 further comprising performing attribute analysis on the digital source image data to identify one or more attributes of the subject, wherein the eyelash recommendation is further based on the one or more attributes.

6. The method of claim 5 wherein the one or more attributes include one or more of a face shape attribute, an age attribute, an eye attribute, an eyebrow attribute, a skin tone attribute, a skin texture attribute, a skin condition attribute, a hair attribute.

7. The method of claim 4, wherein the microrobot control instructions are further based on the eyelash recommendation.

8. The method of claim 4 further comprising:
providing the digital source image data and the eyelash recommendation to an image generation module; and
generating a modified image or 3D model based on the digital source image data and the eyelash recommendation.

9. The method of claim 8 further comprising displaying the modified image or 3D model in an eyelash enhancement user interface.

10. The method of claim 9 wherein the eyelash enhancement user interface further includes virtual try-on functionality that allows modification of the eyelash recommendation via user interaction with the modified image or 3D model.

11. The method of claim 1 further comprising receiving user input from an eyelash enhancement user interface, wherein the microrobot control instructions are further based on the user input.

12. A system comprising:
circuitry configured to obtain digital source image data of a subject;
circuitry configured to define an eyelash region of the subject in the digital source image data;
circuitry configured to generate an eyelash map based at least in part on analysis of the defined eyelash region; and
circuitry configured to generate microrobot control instructions based at least in part on the eyelash map, wherein the microrobot control instructions are configured to cause one or more microrobots to apply one or more artificial lashes to the subject based on the eyelash map.

13. The system of claim 12 further comprising one or more cameras configured to capture the digital source image data of a subject.

14. The system of claim 12 further comprising the one or more microrobots.

15. The system of claim 12 wherein the circuitry configured to define the eyelash region includes circuitry configured to extract facial landmarks from the digital source image data, identify the location and shape of the eyelash region based on the facial landmark points, and apply an image mask corresponding to the eyelash region to the digital source image data.

16. The system of claim 12 further comprising:
circuitry configured to generate an eyelash recommendation based at least in part on the eyelash map, wherein the eyelash recommendation comprises a position on an eyelid or existing eyelash of the subject for an artificial lash to be applied by the one or more microrobots.

17. The system of claim 16 further comprising circuitry configured to perform facial attribute analysis on the digital source image data to identify one or more attributes, wherein the eyelash recommendation is further based on the one or more attributes, and wherein the one or more attributes include one or more of a face shape attribute, an age attribute, an eye attribute, an eyebrow attribute, a skin tone attribute, a skin texture attribute, a skin condition attribute, a hair attribute.

18. The system of claim 16, wherein the microrobot control instructions are further based on the eyelash recommendation.

19. The system of claim 16 further comprising:
circuitry configured to provide the digital source image data and the eyelash recommendation to an image generation module;
circuitry configured to generate a modified image or 3D model based on the digital source image data and the eyelash recommendation;
circuitry configured to display the modified image or 3D model in an eyelash enhancement user interface; and
circuitry configured to receive user input from the eyelash enhancement user interface, wherein the microrobot control instructions are further based on the user input.

20. Non-transitory computer-readable media having stored thereon instructions configured to cause one or more computing devices to perform steps comprising:
obtaining digital source image data of a subject;
defining an eyelash region of the subject in the digital source image data;
generating an eyelash map based at least in part on analysis of the defined eyelash region;
generating microrobot control instructions based at least in part on the eyelash map. wherein the microrobot control instructions are configured to cause one or more microrobots to apply one or more artificial lashes to the subject based on the eyelash map.
